(19) United States
(12) Patent Application Publication
(10) Pub. No.: US 2015/0086063 A1
(43) Pub. Date: Mar. 26, 2015

(54) SPEAKER AND DISPLAY HAVING SAME

(71) Applicant: HON HAI PRECISION INDUSTRY CO., LTD., New Taipei (TW)

(72) Inventor: SEI-PING LOUH, New Taipei (TW)

(73) Assignee: HON HAI PRECISION INDUSTRY CO., LTD., New Taipei (TW)

(21) Appl. No.: 14/055,889

(22) Filed: Oct. 17, 2013

(30) Foreign Application Priority Data
Sep. 25, 2013 (TW) 102134423

(51) Int. Cl. H04R 1/02; H04R 19/02

(52) U.S. Cl. CPC H04R 1/028; H04R 19/02; H04R 2400/03; H04R 2499/15
USPC 381/388; 381/191

(57) ABSTRACT

A speaker includes a hollow glass substrate and a plurality of vibration exciters. The glass substrate defines a hermetical receiving cavity. The vibration exciters are received in the receiving cavity, and are attached to the glass substrate to drive the glass substrate to vibrate, thus generating sound waves. The disclosure further relates a display having the speaker.

### BACKGROUND

1. Technical Field

The present disclosure relates to a speaker and a display.

2. Description of Related Art

Many displays do not have a speaker, therefore, users must connect an external speaker to the display, which is very inconvenient.

Therefore, it is desirable to provide a speaker and a display that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a display, according to a first exemplary embodiment.

FIG. 2 is a partial cross-sectional view of the display taken along a line II-II of FIG. 1.

FIG. 3 is a schematic view of a glass housing of the display of FIG. 1.

FIG. 4 is a cross-sectional view of a display, according to a second exemplary embodiment.

FIG. 5 is a schematic view of a glass housing of the display of FIG. 4.

FIG. 6 is a cross-sectional view of a display, according to a third exemplary embodiment.

### DETAILED DESCRIPTION

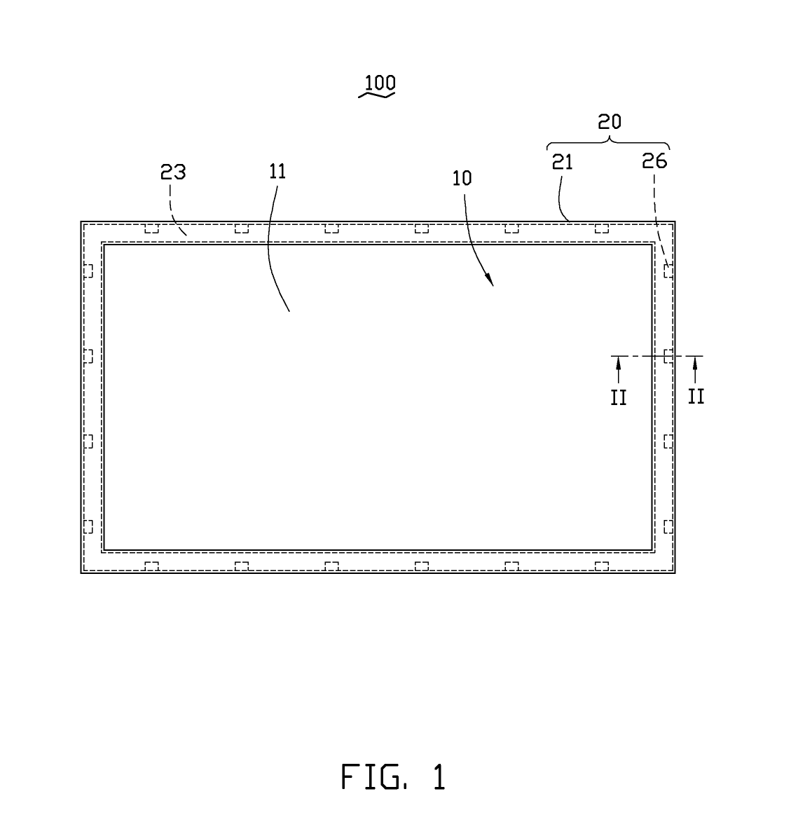

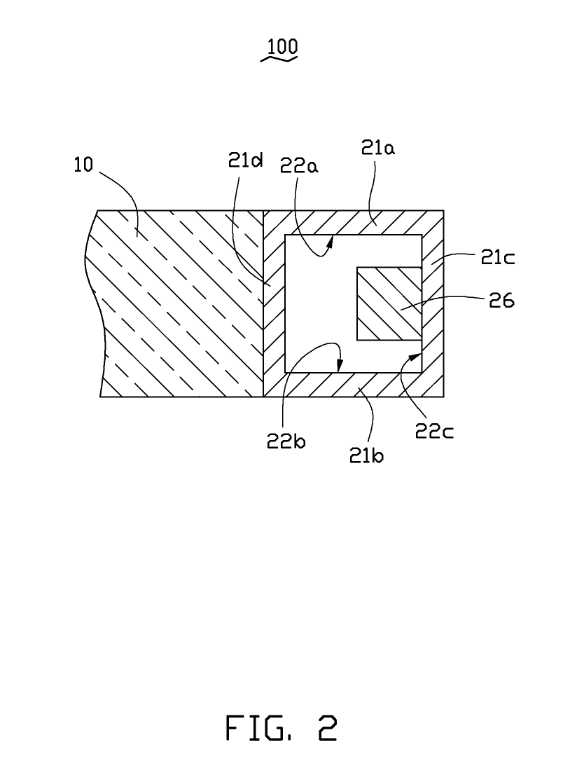

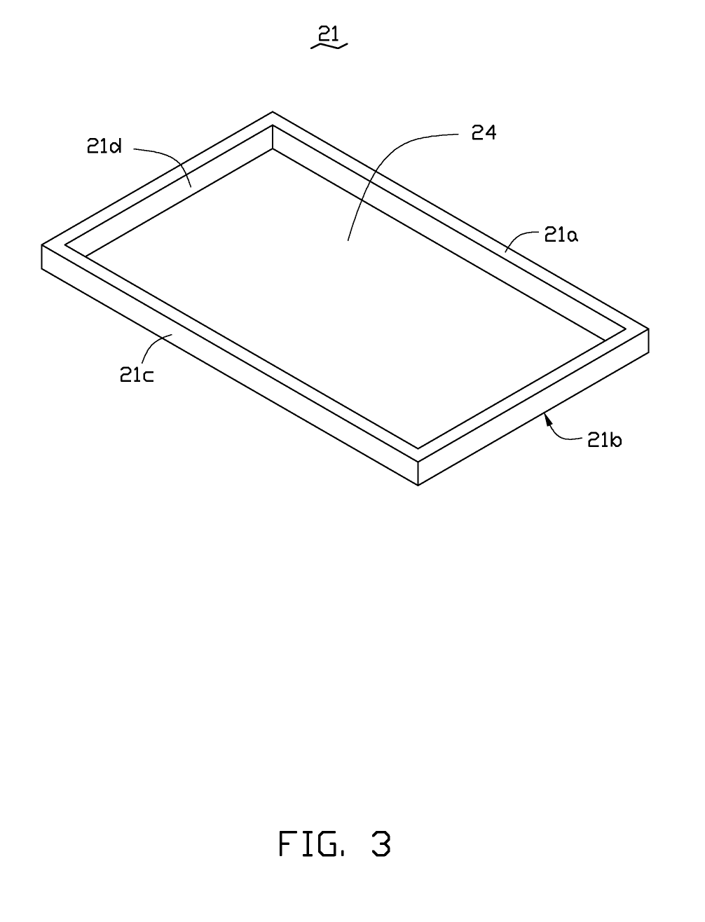

FIGS. 1-3 illustrate a display 100 of a first exemplary embodiment. The display 100 includes a display panel 10 and a speaker 20.

The display panel 10 is used for displaying images according to received image signals. The display panel 10 includes a display surface 11. In the first embodiment, the display panel 10 is a liquid crystal display, and includes a horizontal polarizer, a color filter, a liquid crystal layer, a thin film transistor, a vertical polarizer, a driving circuit board, a diffusion sheet, and a backlight module.

The speaker 20 includes a hollow glass housing 21 and a number of vibration exciters 26. The glass housing 21 is fixed on the display panel 10. The glass housing 21 defines a hermetical receiving cavity 23. The glass housing 21 is substantially rectangular frame-shaped, and includes a front wall 21a, a back wall 21b, an outer wall 21c, and an inner wall 21d. The front wall 21a is adjacent to the display surface 11. The back wall 21b is opposite to the front wall 21a. The outer wall 21c is opposite to the inner wall 21d. Both of the outer wall 21c and the inner wall 21d are connected to the front wall 21a and the back wall 21b.

The glass housing 21 has a through hole 24 passing through the front wall 21a and the back wall 21b. The through hole 24 fits with the display panel 10, and thus the glass housing 21 surrounds the display panel 10. The outer wall 21d is away from the display panel 10. The inner wall 21d is in contact with the display panel 10.

The vibration exciters 26 are received in the receiving cavity 23, and are equidistantly spaced. The vibration exciters 26 are attached to the glass housing 21, and are used for driving the glass housing 21 to vibrate, thus generating sound waves. The vibration exciters 26 may be products HIAX25C10-8/HS or HiHX14CO2-08 of HiWave Technologies PLC.

In the first embodiment, the vibration exciters 26 are attached to an inner surface 22c of the outer wall 21c, and the inner surface 22c of the outer wall 21c is exposed in the receiving cavity 23. In other embodiments, the vibration exciters 26 can be attached to an inner surface 22a of the front wall 21a or an inner surface 22b of the back wall 21b, and the inner surface 22a of the front wall 21a and an inner surface 22b of the back wall 21b are exposed in the receiving cavity 23.

In use, the display panel 10 displays images according to the received image signals, and the vibration exciters 26 drive the glass housing 21 to vibrate, and thus to generate the sound waves.

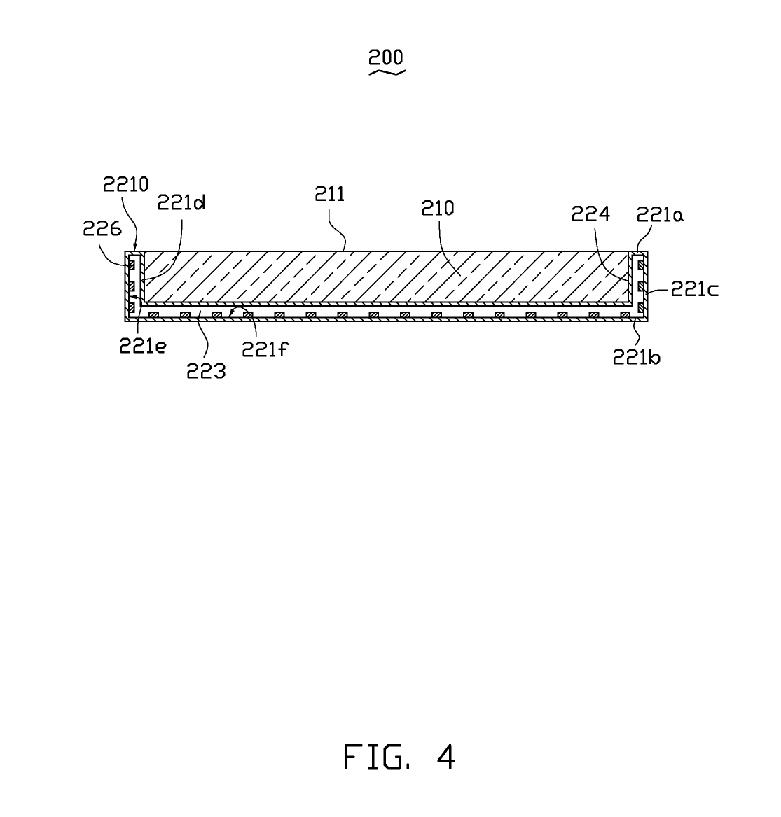

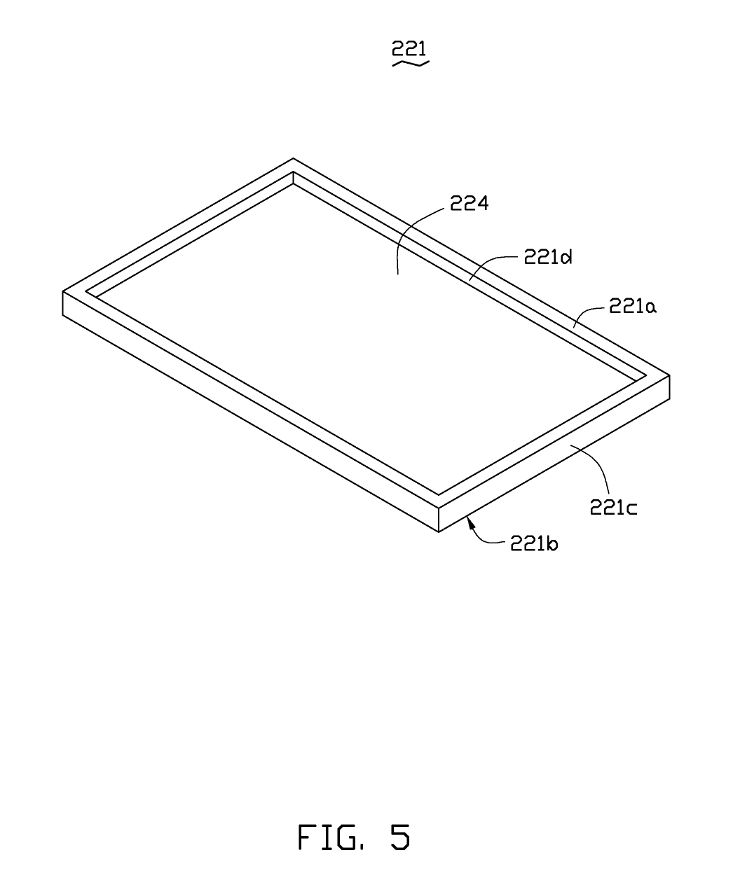

FIGS. 4-5 show a display 200 according to a second exemplary embodiment. The differences between the display 200 and the display 100 are that, a particular surface 2210 of the glass housing 221 defines a receiving recess 224 rather than the through hole 24. The receiving recess 224 is used for receiving the display panel 210, and the display surface 211 is exposed from the receiving recess 224. The display surface 211 and the particular surface 2210 are at a same planar surface.

The glass housing 221 has a hermetical receiving recess 223, and includes a front wall 221a, a back wall 221b, an outer wall 221c, and an inner wall 221d. The front wall 221a, the outer wall 221c, and an inner wall 221d are substantially rectangular frame-shaped, and the back wall 221b is substantially a planar surface. The front wall 221a is adjacent to the display panel 210. The back wall 221b is opposite to the front wall 221a. The outer wall 221c is opposite to the inner wall 221d, and is connected to the front wall 221a and the back wall 221b. The inner wall 221d is connected to the front wall 221a. The inner wall 221d is in contact with the display panel 210, and is received in the receiving recess 223. The outer wall 221c is away from the display panel 210.

In the second embodiment, the vibration exciters 226 are attached to an inner surface 221e of the outer wall 221c and an inner surface 221f of the back wall 221b. The inner surface 221e of the outer wall 221c and the inner surface 221f of the back wall 221b are exposed in the receiving cavity 223. The inner surface 221e of the outer wall 221c is connected to the inner surface 221f of the back wall 221b. In other embodiments, the vibration exciters 226 are attached to the inner surface 221e of the outer wall 221c or the inner surface 221f of the back wall 221b.

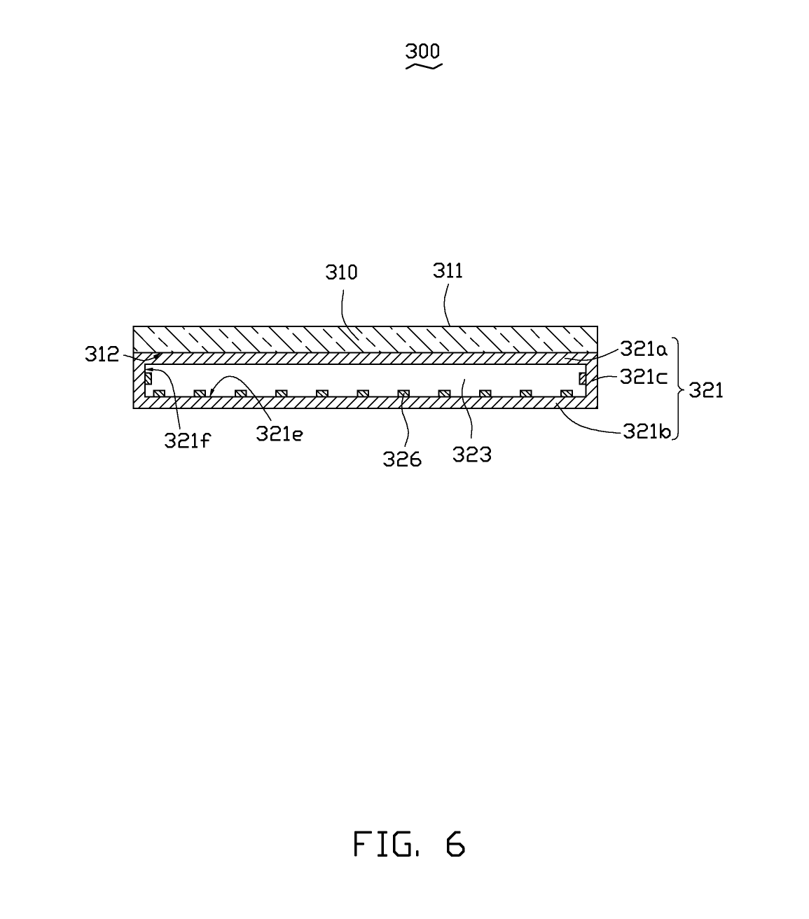

FIG. 6 shows a display 300 according to a third exemplary embodiment. The differences between the display 300 and the display 100 are that, the display panel 310 has a display surface 311 and a back surface 312 opposite to the display surface 311. The glass housing 321 is fixed on the back surface 312. The glass housing 321 defines a hermetical receiving cavity 323, and has a front wall 321a, a back wall 321b, and four sidewalls 321c. The front wall 321a is in contact with the display panel 310. The back wall 321b is opposite to the front wall 321a, and is away from the display panel 310. The four sidewalls 321c are connected to the front wall 321a and the back wall 321b. In the third embodiment, the vibration exciters 326 are attached to an inner surface 321e of the back wall 321b and four inner surfaces 321f of the four sidewalls 321c. The inner surface 321e of the back wall 321b and four inner surfaces 321f of the four sidewalls 321c are exposed in the receiving cavity 323, and the inner surface 321e of the back wall 321b is connected to the inner surfaces 321f of the four sidewalls 321c.

In other embodiments, the vibration exciters 326 can be only attached to at least one of the inner surface 321e of the back surface 321b or the four inner surfaces 321f of the four sidewalls 321c, or the vibration exciters 326 can be only attached to the four inner surfaces 321f of the four sidewalls 321c.

By employing the display with the speaker, an external speaker connected to the display can be omitted, which is very convenient.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A speaker, comprising:
a hollow glass housing defining a hermetical receiving cavity; and
a plurality of vibration exciters received in the receiving cavity, and being attached to the glass housing to drive the glass housing to vibrate, thus generating sound waves.

2. The speaker of claim 1, wherein the vibration exciters are equidistantly spaced.

3. A display, comprising:
a display panel; and
a speaker positioned on the display panel, the speaker comprising:
a hollow glass housing defining a hermetical receiving cavity; and
a plurality of vibration exciters received in the receiving cavity, and being attached to the glass housing to drive the glass housing to vibrate, and thus generating sound waves.

4. The display of claim 3, wherein the glass housing is substantially rectangular frame-shaped, and surrounds the display panel.

5. The display of claim 4, wherein the glass housing has an inner wall and an outer wall opposite to the inner wall, the inner wall is in contact with the display panel, the vibration exciters are positioned on an inner surface of the outer wall, and the inner surface of the outer wall is exposed in the receiving cavity.

6. The display of claim 3, wherein the glass housing is cuboid, the glass housing defines a receiving recess receiving the display panel therein, the display module has a display surface, the display surface is exposed from the receiving recess.

7. The display of claim 6, wherein the glass housing has a front wall, a back wall, an inner wall, and an outer wall, the front wall is adjacent to the display surface, the back wall is opposite to the front wall, and is away from the display module, the outer wall is connected to the front wall and the back wall, the vibration exciters are positioned on an inner surface of the outer wall and an inner surface of the back wall, the inner surface of the outer wall and the inner surface of the back wall are exposed in the receiving cavity, the inner surface of the outer wall is connected to the inner surface of the back wall.

8. The display of claim 6, wherein the glass housing has a front wall, a back wall, and an outer wall, the front wall is adjacent to the display surface, the back wall is opposite to the front wall, and is away from the display surface, the inner wall is exposed in the receiving recess and is in contact with the display panel, the outer wall is opposite to the inner wall, and is away from the display surface, the outer wall is connected to the front wall and the back wall, the vibration exciters are positioned on the inner surface of the outer wall or the inner surface of the back wall, the inner surface of the outer wall and the inner surface of the back wall are exposed in the receiving cavity, the inner surface of the outer wall is connected to the inner surface of the back wall.

9. The display of claim 3, wherein the display panel has a display surface and a back surface opposite to the display surface, the glass housing is attached to the back surface.

10. The display of claim 9, wherein the glass substrate has a front wall, a back wall, and at least one sidewall, the front wall is in contact with the display panel, the back wall is opposite to the front wall, the at least one sidewall is connected to the front wall and the back wall, the vibration exciters are positioned on an inner surface of the back wall and an inner surface of the at least one sidewall, the inner surface of the back wall and the inner surface of the at least one sidewall are exposed in the receiving cavity, and the inner surface of the back wall is connected to the inner surface of the at least one sidewall.

11. The display of claim 9, wherein the glass substrate has a front wall, a back wall, and at least one sidewall, the front wall is in contact with the display module, the back wall is opposite to the front wall, the at least one sidewall is connected to the front wall and the back wall, the vibration exciters are positioned on an inner surface of the back wall or an inner surface of the at least one sidewall, the inner surface of the back wall and the inner surface of the at least one sidewall are exposed in the receiving cavity, and the inner surface of the back wall is connected to the inner surface of the at least one sidewall.
